(19) United States
(12) Patent Application Publication
(10) Pub. No.: US 2005/0267872 A1
(43) Pub. Date: Dec. 1, 2005

(54) System and method for automated mapping of items to documents

(76) Inventors: Yaron Galai, New York, NY (US); Oded Itzhak, Hoboken, NJ (US); Ilan Itzhak, New York, NY (US)

Correspondence Address: Richard M. Lehrer, Esq.;Mintz, Levin, Cohn, Ferris, Glovsky and Popeo, P.C, The Chrysler Center, 666 Third Avenue, 24th Floor, New York, NY, 10017, US

(21) Appl. No.: 11/069,686

(22) Filed: Mar. 1, 2005

Related U.S. Application Data
(60) Provisional application No. 60/576,090, filed on Jun. 1, 2004.

(51) Int. Cl. G06F 7/00

(52) U.S. Cl. 707/3

(57) ABSTRACT

The present invention provides methods and systems for automated mapping of advertisements to web pages. It provides the ability to provide target advertising and it provides the ability to sell key terms related to a particular advertisement. The invention also provides the ability to suggest key terms to potential purchasers based upon a content of the advertisement or based upon some other related information provided by the purchaser. The present invention also provides the ability to map the advertisements based on categories of semantically unrelated words and phrases. The method for mapping the advertisement to the web page includes analyzing the web page to determine its content. The content is then compared to a list of key terms. If the comparison results in a match and the match includes a key term, which has been purchased by an advertiser, that advertiser's advertisement may be mapped to the web page.

### CROSS-REFERENCE TO RELATED APPLICATIONS

This application claims the benefit of U.S. Provisional Application No. 60/576,090, filed Jun. 1, 2004, and entitled System And Method For Automated Mapping Of Keywords And Key Phrases To Documents and hereby incorporates that application by reference as if fully set forth herein.

### STATEMENT REGARDING FEDERALLY SPONSORED RESEARCH

N/A

### REFERENCE TO SEQUENCE LISTING

N/A

### BACKGROUND OF THE INVENTION

1. Field of the Invention

The present invention relates generally to systems and methods for automated mapping of items to documents, and more particularly to systems and methods in which a content of a document is compared to a list of key terms and associated feature vectors and based on the results of the comparison items are associated with the documents.

2. Description of Related Art

Various search engines exist for finding web pages on the Internet. Directories, such as the Yahoo™ directory, use human editorial teams to categorize websites into a categorical tree. These directories are similar to telephone directories in that a desired service provider can be located by entering words related to the desired service. For example, the term “auto repair” could be employed to find a web site for Joe's Auto Repair Shop. The term “auto repair” is compared to the categorical tree and a list of matches is displayed.

Search engines, such as Google™, Yahoo™, MSN™ or Teoma™, send “spiders” across the Internet in an attempt to visit every page of every web site. The information they find is then indexed. These indexes contain the words that have been extract from the pages found by the spiders. A search query is compared against the index and a list of relevant search results is constructed.

Another type of conventional search engine enables website owners to manually insert key terms of their choice into the search index. This type of service is operated for example by companies such as Overture™ and FindWhat™. As with the previous search engines, a search query is compared against the index. Usually a “hard match” is required between the submitted search query and the index for results to be provided. Some search engines have recently begun taking into consideration “broad matches” which allow for misspellings, plurals, and sub-sets of the query. However, none of these search engines takes semantic matching. Website owners that submit a web page to conventional search services have to select the Key Terms that best fit the submitted web page. For example, the terms ‘Harry Potter’ and ‘book’ could be submitted for a certain page within an online bookstore. Any time these terms are submitted as a search query, the web page would probably appear within the search results (depending on the specific ranking algorithms used by the search service). However, a search query with different terms would not bring up the same web page, even if one or more of the search terms appeared somewhere within the text of that web page. For example, the word ‘Quidditch’ may appear within the text of the web page, but this search term will not be matched by the conventional search service to the web page since the website owner did not submit this term to the index. In certain instances the same holds true for a search query containing a spelling error, a partial query (which only includes a sub-string of the indexed key terms such as Potter), a query in which the words do not appear in the same order as is in the index, etc. In all such cases the search service may not provide search results to the submitted query.

One attempt to increase the utility of search engines, by providing an “intelligent” search for concepts related to the submitted query, is described in U.S. Pat. No. 6,453,315, which is assigned on its face to Applied Semantics Inc. This patent discloses a method for mapping relationships between concepts, so that the closeness in “meaning” between a search query and searchable information is determined. Searchable information, which is closest in “meaning” to the query, may then be used to achieve the desired search results.

A drawback to such a method is that “meaning” is both relatively vague and difficult to determine. The determination of “closest in meaning” is also difficult to determine. The above-referenced patent attempts to determine “meaning” by defining a semantic space of similar or related concepts. These concepts must be predetermined in terms of their relationships and similarity to each other; the key terms can then be mapped to the concepts, for determining “closest in meaning”. Target web pages can then be assigned locations within the semantic space as part of preprocessing, before a search query is submitted. These locations relate to the score of the target web page for particular mapped concepts.

Although this method has the advantage of being capable of a mathematical implementation, and hence of being operated by a computer, it has many disadvantages. In particular, it requires predetermined relationships between concepts to be known before any processing of target documents is possible. In other words, the content of the actual web pages must be subordinate to the previously determined conceptual map. Should the content fail to be well expressed or well determined by the conceptual map, then either the map must be redone or the search queries may fail to obtain the most relevant documents. Thus, the above-referenced patent fails to describe a method, which may be flexibly adjusted according to the content of the web pages.

Targeted advertising on the Internet is conventionally performed when advertisers purchase (or bid for) key terms from search engines. Traffic directed to web sites based on submitted search queries, which are identical or very similar to the purchased key terms are provided advertisements from those advertisers. However it is up to the advertiser to select the key terms to purchase. This requires the advertiser to essentially guess all the terms and variations (including misspellings, sub-strings, contextually similar terms, etc.) that might be employed by potential customers.

The most common business model is the pay-per-click through (PPC) model where the advertiser pays for each click-through to his Web site. Hereinafter, the term “PPC search engine” refers to any type of search engine that compares a search query against a list of pre-submitted key terms that are assigned to web pages. For example, U.S. Pat. No. 6,269,361 (“the '361 patent”) discloses a system for allowing a web site owner to influence the position of an advertisement in search results presented to a user, by purchasing the position and/or paying money to positively influence the location of the web site in the search results.

As noted above with regard to the patent assigned to Applied Semantics, targeted advertising is only as accurate as the method of targeting. The method described in the '361 patent is rigid, and may fail when those who are determining the concept mapping do not understand cultural or other differences (e.g. when attempting to prepare such a map for different countries and/or languages). Thus, it would be advantageous to provide an improved method for determining the “meaning” of web pages and other documents. It would be further advantageous to provide a system, which enabled targeted advertisements based on the “meaning” of a document.

### BRIEF SUMMARY OF THE INVENTION

Many advantages of the present invention will be determined and are attained by the present invention, which in one aspect provides a flexible method for determining content of web pages and other documents.

An embodiment of the invention includes a system for mapping an item to a document. The system includes a server configured to receive a document and to determine a content of the document. The system also includes a mapping module in communication with the server. The mapping module is operative to correlate a key term to the content. The system also includes an item database that is in communication with the server. The item database is configured to store items. The server is configured to receive a key term correlated to the content from the mapping module, obtain an item from the item database, based at least in part on the key term mapped to the content and to map the item to the document.

Another embodiment of the invention provides a method for mapping an item to a document. The method includes receiving and analyzing the document to determine a content thereof. The method also includes comparing the content with a set of key terms, and correlating an item to at least one of the key terms. The method further includes mapping the item to the document based on the results of the comparison including a match between the content and the key term.

Still another embodiment of the invention provides a method for mapping an item to a document. The method includes receiving and analyzing a document to create a document feature vector. The method also includes comparing the document feature vector with a set of key terms and related key term feature vectors.

Yet another embodiment of the invention includes a system for mapping an item to a document. The system includes a module for receiving a document and a determining a content of the document. The system also includes a module for correlating a key term to the content. The module for correlating is in communication with the module for receiving. The system also includes an item database, in communication with the module for receiving, which is configured to store items. The module for receiving is configured to receive a key term correlated to the content from the module for correlating, obtain an item from the item database based at least in part on the key term correlated to the content and to map the item to the document.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE SEVERAL VIEWS OF THE DRAWINGS

The invention is herein described, by way of example only, with reference to the accompanying drawings, wherein:

FIGS. 1A and 1B are flowcharts of exemplary methods according to the present invention;

FIG. 2 shows an exemplary system according to the present invention;

FIG. 3 shows a flowchart of an exemplary method for targeted advertising according to the present invention;

FIG. 4 shows a flowchart of one embodiment of a method for enabling an advertising web site promoter to interact with a characterization service;

FIG. 5 shows a flowchart of one embodiment of a method for enabling a content provider to interact with a characterization service;

FIG. 6 shows a flowchart of one embodiment of a method for use in classifying content into topics as shown in FIG. 4 or 5;

FIG. 7 shows one embodiment of a system for characterizing advertisement content; and

FIG. 8 shows one embodiment of a system for selecting an advertisement.

### DETAILED DESCRIPTION OF THE INVENTION

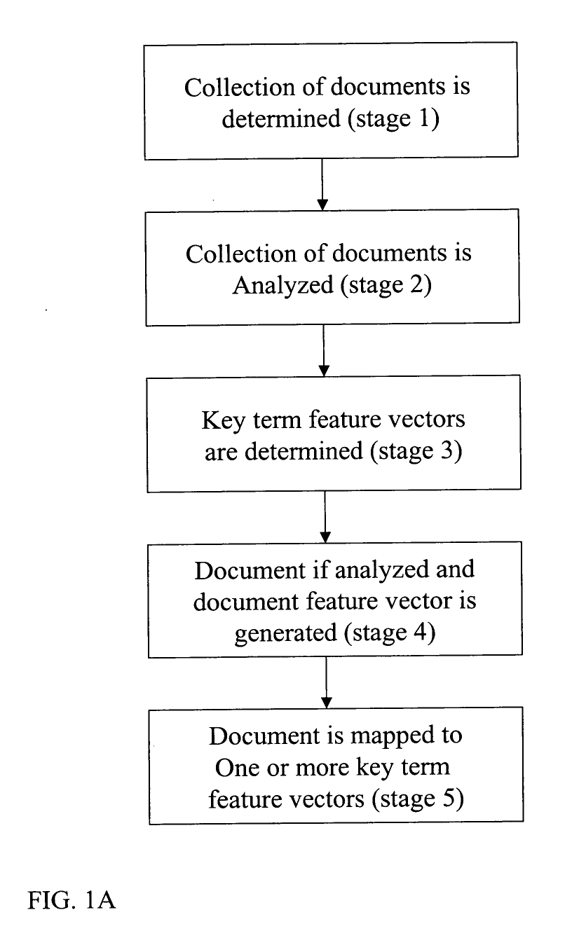

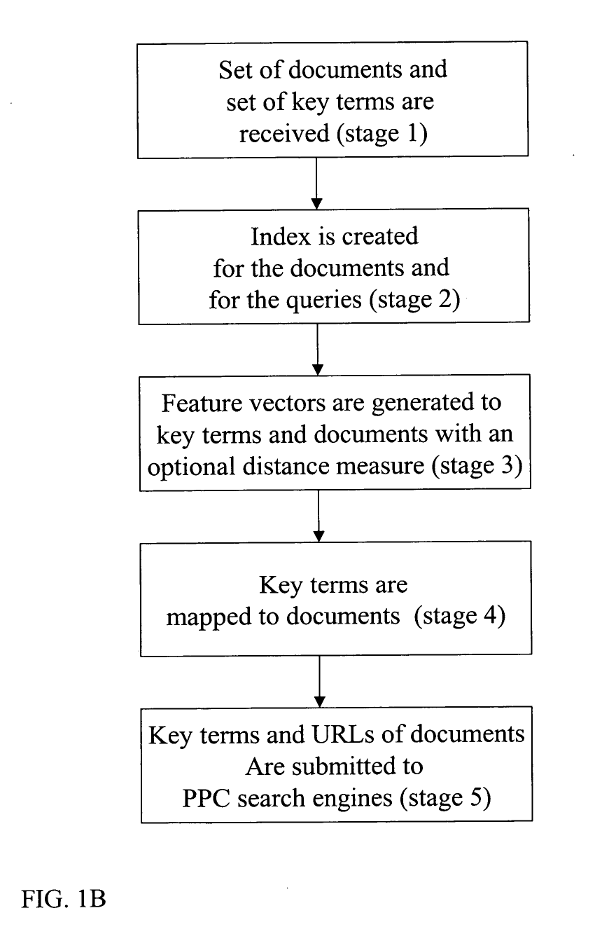

Referring to the drawings in detail wherein like reference numerals identify like elements throughout the various figures, there is illustrated in FIGS. 1-8 systems and methods according to the present invention. The principles and operation of the method according to the present invention may be better understood with reference to the drawings and the accompanying description. It should be noted that the present invention is operable with any type of document and any type of item.

The present invention provides a flexible method for determining content of a document. The use of the term “document” herein shall refer to one or more web sites, web pages, search queries, partial search queries, URLs, emails, advertisements and text documents either alone or in combination. A content of a document is determined and then it is determined whether a relationship exists between the content and another document and/or key words or key phrases (“key terms”) and if such a relationship exist what the relationship is. The relationship is then employed to map an item, such as another document, multiple other documents, a key term and/or key terms to that document.

FIGS. 1A and 1B show different methods according to the present invention for mapping items to searchable documents. FIG. 1A shows an exemplary method which determines a feature vector made up of key terms. The feature vector may be employed for matching the key terms to the most relevant document(s) by content for submission to a PPC engine, and/or for other applications such as targeted advertising, as described in greater detail below.

FIG. 1B illustrates another embodiment of the present invention. As for FIG. 1A in stage 1, a corpus of documents is received. However, a set of key terms may also be received, which preferably is derived from a list of actual search queries submitted by users to a search engine. The set of queries may also include frequency information, for example—as to the frequency or rate at which the queries were submitted. Stage 1 may also optionally be performed by having a page retrieval module crawl a target web site and retrieve pages.

Key Terms may be acquired from various sources, including manually compiled lists, purchased lists, lists of words and phrases purchased by advertisers from a PPC search engine, actual search queries, and/or any other source or a combination thereof. Key Terms may also include “categories” of seemingly unrelated words and phrases, which are identified by a word or phrase. For example, the words music, fitness, and dating are semantically unrelated, however, these words can all be correlated to the category TEENS since these are all issues with which teens are concerned. There are countless examples of categories of this kind that may be employed. Accordingly, the term key term as used herein may also refer to categories of key terms.

A key term may also be associated with additional information for further characterizing the key term, including but not limited to its popularity or any categories it is associated with.

The mapping process of the present invention may be performed in multiple parts. A pre-processing part is preferably performed first (although it could also be performed simultaneously or subsequently if speed or time is not an issue), to generate a list of key terms and related feature vectors (“key term feature vectors”). Key term feature vectors are correlations between key terms and related words and phrases. Key term feature vectors may also include rankings or weights for each of the related words or phrases and/or any other distinguishing features related to the words and phrases. Ranks or weights may be assigned according to the relevance of the word or phrase to the key term and according to the uniqueness of the word or phrase relative to the key term. Those skilled in the art will recognize that other ranking systems may be employed without departing from the scope of the present invention.

By way of example, a key term feature vector for the key term AUTOMOBILE might include the words and phrases car, motorcycle, all-terrain-vehicle, and vehicle and may include weights for each. For instance car may be assigned the greatest weight since it is the closest in meaning to automobile and since in this instance it is unique as well. Alternatively, one of the other words or phrases might be assigned the greatest weight depending on the weighting system employed. Those skilled in the art will recognize that this illustration is merely for explanatory purposes only and in no way limits the key term feature vector for AUTOMOBILE to this particular example or limits the key term feature vectors to AUTOMOBILE.

Many of the key term feature vectors may be automatically generated by analyzing a collection of documents, (hereinafter a “corpus”), but some may need to be generated manually, or by a combination of automated and manual processes. Weightings of the words and phrases in the key term feature vectors may be performed manually, but more preferably is performed automatically.

For automatic generation of key term feature vectors, the following non-limiting, illustrative method may be employed in accordance with the present invention. A corpus of related or unrelated documents is determined. These documents are analyzed, which may include extracting features/words/phrases/links to other documents/etc. (“features”) from the documents, determining semantic relations between the features, detecting statistical patterns, indexing features of the documents, clustering the documents, categorizing the features or characteristics and/or the documents themselves, searching the documents and/or analyzing previous search queries or results, and ranking the documents, for example according to some measure of relevancy. The document may be associated with additional information for characterizing it, including but not limited to, category, related documents, and/or related keywords. The document may optionally be in the XML or HTML formats, and/or any other format.

The feature vector of each key term is preferably generated using data generated in the corpus analysis process. It is possible that a feature vector is a null vector if no words or phrases are related to a particular feature. Key terms and their key term feature vectors are then optionally indexed, to enable fast retrieval during the document mapping process.

Optionally, the key term feature vectors or the corpus analysis may then be used to determine one or more “themes”, which express relationships between the documents. While such themes may be determined without the use of theme feature vectors it is preferable for each theme to have at least one associated theme feature vector. Alternatively, such themes may be generated manually and/or from some other type of input.

Once determined, the key terms, key term feature vectors, themes and theme feature vectors may all be combined to create a reference list for use with the present invention.

Another part of the mapping process, document mapping, involves mapping key terms to a particular document or group of documents. This part may be performed in substantially real time, such that it is performed as the document is being received or thereafter. Document mapping may be performed in a number of ways.

One or more document feature vectors may be created, and then the document feature vector(s) compared to the key term feature vectors and/or the theme feature vectors. Given a document for which key terms are to be mapped, a document feature vector may be generated for the document. The document feature vector may include words and phrases extracted from the document but may optionally include words and phrases that do not appear in the document, such as synonyms, related words, misspellings of words, words entered into the document by a user, etc. The document feature vector may also include any content from the particular document. For example, selections from a menu such as a drop-down menu, or combinations of selections from one or more menus could be employed as elements of the document feature vector(s). Alternatively, the mapping may be limited to specific portions of the documents, such as title, part of the description, etc. If the content of the document is too diverse (e.g. in the case of a front page of an online newspaper or a dating service page, etc.), other features of the document could be employed such as the search queries employed most often to reach the document or any other measurable and distinguishable feature. Each element in the document feature vector is preferably, although not required to be, weighted.

Once the document feature vector(s) is determined, the theme feature vectors may be compared to the document feature vectors. The results of the comparison may be scored according to their relative similarity. Such scores may be used for determining similarity of one or more themes to the document and/or otherwise mapping the theme to the document, for example by determining the distance between the various feature vectors. Distance measurements may be determined at least partially according to a weighting of elements in the various feature vectors. The similarity of one or more themes to the document may also be used for determining similarity between the document and one or more other items discussed further below. Alternatively or in conjunction with this method the key terms in the key term list and/or the key term feature vectors could be compared directly to the content of the document. As with the creation of the document feature vector, any content of the particular document or documents may be employed for the comparison.

Alternatively, the key term feature vectors may be matched directly to the document feature vector(s) in order to determine the relationship between key terms and documents, for example according to similarity or lack thereof. Such matching may take into consideration weighting of the elements in each the various feature vectors.

Once the document mapping has been performed an item may be mapped to the document. Alternatively multiple items could be mapped to the document. For purposes of this invention, mapping an item to a document includes adding the item to the document and/or presenting the item with the document. Further, an item may be anything that can be added to the document and/or presented with the document. For example, an item may be an advertisement, a sound file, a graphic file, a video file, text, another document, or any combination thereof.

The following are some non-limiting examples of mapping an item to a document in accordance with the present invention. The following examples are in no way limiting as to the type of items which can be mapped to particular documents nor as to the results of the comparison between the document and the taxonomy list.

In the situation wherein the document is a search query made up of one or more search terms, the item may be one or more additional search terms. The new search query, which includes both the original search query and the additional search term(s) could then be employed in any conventional search engine (e.g. a PPC search engine) to locate relevant web sites. For example, if the original search query is “Travel to Paris” the comparison between the document and the previously described taxonomy list might result in the key terms Air France and Hotels being added to the search query. It is also possible that the additional search terms replace the original terms entirely. The present invention could then be employed for the further step(s) of mapping an item to the search results and/or to a web site selected from search results.

In a situation where the document is a web page, the item could be any of the above listed items. For example, if the web page is one related to bicycle tours the item could be an advertisement for a particular brand of bicycle or bicycle parts. The advertisement could include graphics, text, sound, video, a URL or any combination thereof and could be presented in any conventional manner (e.g. as a pop-up, pop-under, banner, etc.).

If the document is an email message it might include a link to a particular web page that the sender thinks would interest the recipient. It will be understood by those skilled in the art that this example could also apply to a web page or any other document that includes a link. The link could be extracted from the email and either additional links, text or targeted advertisements could be added to the email. Additionally or alternatively the link could be modified to redirect the recipient to the system of the present invention thus enabling the destination web page to be provided to the system. This would enable the destination web page to be analyzed by the system and an item could be mapped to the destination web page.

If the document is a URL, the URL could be analyzed in accordance with the invention and either additional URLs could be supplied, the URL could be modified or replaced or the destination document could be analyzed in accordance with the invention and an item mapped to that destination as described above.

An aspect of the present invention is the ability to offer key terms for sale. These key terms could be purchased for a set price, on a PPC basis or on a bidding basis. The purchaser could be allowed to select key terms from the entire list or a list of suggested key terms could be provided to the potential purchaser. Potential purchasers (e.g. advertisers, political campaign promoters, surveyors, etc) may select the key terms manually, for example by browsing or searching the taxonomy. To use the present invention for targeted advertising optionally the selected key terms and their relevancy to the purchaser's item may be sent to an editor for approval or rejection prior to allowing an item from that purchaser to be mapped to a document.

Alternatively or in conjunction with the manual selection with key terms, the system may suggest a list of key terms from which a potential purchaser can select. This aspect of the invention includes receiving a URL for advertising content or some other item to be mapped to the document. The URL and/or the advertising content is then analyzed in the manner discussed above with regard to document mapping. The results may be provided to the potential purchaser or a subset of the results could be provided. Those skilled in the art will recognize that other information could be provided to the system for return of key term suggestions. For example, a potential purchaser could input a desired search term and the system could provide key terms based on the provided term. Other input possibilities are available without departing from the scope of the present invention.

A conventional system that sells words and phrases for targeted advertising generally provides an unlimited list of terms or combination of terms from which the potential purchaser may choose. An embodiment of the present invention makes use of a taxonomy of key terms where the number of available key terms ranges between 250 and 200,000, more preferably between 500 and 100,000 and most preferably between 1,000 and 10,000. Those skilled in the art will recognize that other ranges are available without departing from the scope of the present invention. An advantage of using a limited set of key terms is that it has the potential to drive up the price of bids on the key terms more rapidly, because advertisers are competing in a smaller space.

Additionally, conventional systems are limited to the purchase of conventional words and phrases. The present invention enables a purchaser to purchase categories (previously defined). The advantage of using categories as opposed to words and phrases is that categories have more meaning to an advertising promoter who may not have familiarity with an appropriate set of words and phrases that will provide a good match with the promoter's advertising content. In an embodiment of the present invention the potential list of purchasable key terms may be limited to categories.

The invention contemplates various strategies for mapping items to documents. An example includes selecting items based on the key terms associated with the content of the document in combination with the highest bid for the relevant key terms. Another example includes selecting items based on the key terms associated with the content of the document in combination with the value of the purchaser's bid for the key term and the relevancy of the key term to the purchaser's content. Still another example provides selecting items based on the key terms associated with the content of the document in combination with yield optimization. Yield optimization is the optimization of the cost per click multiplied by the click through rate as is known by those of ordinary skill in the art.

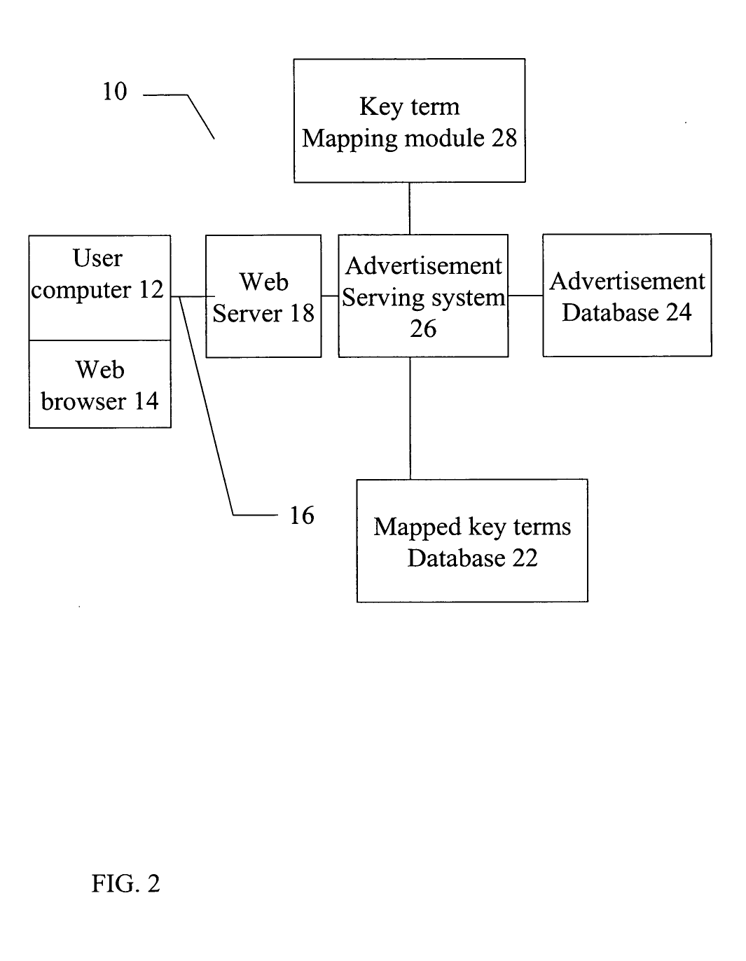

FIG. 2 shows an exemplary system according to an embodiment of the present invention, which is related to targeted advertising. While the following description is limited to web pages and advertisements the invention is not so limited and may include all document types and items discussed above. As shown in system 10, a user computer 12 preferably operates a web browser 14 or any other type of document viewer. those skilled in the art will recognize that user computer 12 may be any type of device that has browser capabilities such as a cellular phone, PDA, portable computer, desk top computer, etc. User computer 12 is preferably connected to a network 16, such as the Internet, although network 16 could optionally be a LAN (local area network), a WAN (wide area network), and/or any combination of networks (which could also optionally include the Internet). Through network 16, user computer 12 can access web pages and/or other documents being served by web server 18.

When a request for a page identified by a URL is received by web server 18, web server 18 submits the requested URL to an advertisement serving system 26 (which may be any type of server or multiple servers; also, advertisement serving system 26 may include a server for performing an analysis according to key terms and an advertising server). Alternatively, advertisement serving system 26 can receive the URL directly from web browser 14.

Advertisement serving system 26 preferably parses the URL, and parses the content in the document matching the URL and/or other types of information submitted by the user. Additionally, the query may be a request using key terms entered into a search engine. For the former type of query, advertisement serving system 26 preferably examines the requested web page and/or the URL (which may also contain information as terms in the URL) in order to obtain a set of key terms. If the document has been previously examined, then preferably advertisement serving system 26 can retrieve the key terms from a mapped key terms database 22. If the document has not been previously examined, then content extracted from the document and/or the entire document and/or the URL of the document are submitted to key term mapping module 28, which maps key terms to documents, and optionally stores the mapping in mapped key terms database 22. These key terms may be used directly by advertisement serving system 26 to select an advertisement from an advertisement database 24. Again, although this description centers on advertisements, the present invention could also optionally be used for selecting other types of additional item(s).

Advertisement serving system 26 then preferably communicates with advertisement database 24 to select one or more advertisements. In any case, advertisement serving system 26 preferably provides the results in the form of an XML page, if requested by web server 18, or in the form of an HTML if requested by a web browser 14.

The structure of system 10 may be varied. For example, user computer 12 may communicate directly with advertisement serving system 26, which may also communicate directly with advertisement database 24. However, preferably user computer 12 communicates with advertisement serving system 26, and/or with web server 18 directly. Advertisement serving system 26 may handle all communication with key term mapping module 28 and with advertisement database 24.

According to embodiments of the present invention, advertisement serving system 26 and/or key term mapping module 28 may be capable of automatically identifying Web pages with undesirable content (from the perspective of an advertiser), such as pornography, terrorism, hate, crimes, and so forth, and/or other types of themes and may then optionally indicate the relevancy of the page content to these themes in the response provided, for example in the XML page. This information can optionally be used by advertisement serving system 26 and/or key term mapping module 28 and/or advertisement database 24 in order to block advertisements from appearing on those web pages in the case of undesirable and/or unsuitable content, and/or for other purposes.

The web server 18, advertisement serving system 26, advertisement database 24, mapped key terms database 22 and/or key term mapping module 28 may be provided in separate entities or as a single entity.

According to embodiments of the present invention, advertisement serving system 26, advertisement database 24 or key term mapping module 28, or a combination thereof, forms an advertisement formatting module (not shown), which is capable of automated conversion of text advertisements to banner display advertisements such as banner “gifs”, according to any banner sizes.

Either key term mapping module 28 and/or advertisement serving system 26 may be capable of performing a relevancy algorithm by examining the relevancy of an advertisement to a submitted URL (and/or to the submitted query and/or other information), according to associated information about the advertisement. Such associated information preferably includes a title and/or description of the, advertisement. This additional feature provides a significant improvement in advertisement relevancy in cases where key terms may have multiple meanings.

During the set-up process for a new potential purchaser of key terms, the potential purchaser's web site may be crawled, and relevant key terms mapped from an existing collection to each URL that is detected during the crawling process. The mapping may then be loaded into mapped key terms database 22.

Each time key terms and/or a request for a document arrives at advertisement serving system 26 and/or key term mapping module 28, a response may be generated. If the normalized form of the URL exists in mapped key terms database 22, an XML document (or other type of message) with the corresponding keywords and their scores is preferably generated and sent back.

If the URL is not in the cache or has expired, the URL may be queued for processing, and a response indicating that the URL is being processed returned. In this case, the URL may be sent to key term mapping module 28 for processing, preferably after sending all pending URLs with a higher priority that are queued on advertisement serving system 26 and/or key term mapping module 28.

The set-up process for enabling advertisement serving system 26 and/or key term mapping module 28 to be able to map key terms to portions of the information of the web page in order to improve relevancy may be performed using conventional machine-learning algorithms. Key term mapping module 28 extracts specific portions of each web page and assigns them appropriate weights.

System 10 may includes a module (not shown) that monitors the web site on an ongoing, but not necessarily continuous, basis to alert when the site structure and/or the URL structure and/or the content on the processed web pages has changed.

In embodiments in which advertisement serving system 26 is operative with multiple publishers (e.g. multiple web servers 18), advertisement serving system 26 may assign an identifier for each publisher or advertisement network. This identifier is preferably passed with each query.

During the setup process, the publisher be provided the ability to adjust the algorithm parameters to impact one or more of the following characteristics: maximize relevancy of listings vs. sold inventory; set the balance between relevancy maximization and profit maximization, for example by adjusting the cost per click or other cost measure for an advertisement, against the relevancy of that advertisement to the submitted information, such as a URL; and disable advertisement serving on web pages with undesirable content such as pornographic materials.

In an embodiment of the present invention, although advertisement serving system 26 and key term mapping module 28 may be a combined entity, this combined entity may include multiple servers (not shown). As such advertisement serving system 26 and key term mapping module 28 would each include multiple servers (which could be multiple computers and/or multiple threads or processes). A management server (also not shown) preferably controls the interaction between the groups of servers.

Advertisement serving system 26 preferably handles requests from external servers (including but not limited to web servers, publishers or search engines), and preferably serves advertisements or key terms in a form of an XML document.

Key term mapping module 28 servers are preferably responsible for generating or mapping relevant key terms for URLs and/or other documents.

The management server preferably dispatches keyword generation requests for URLs to key term mapping module 28 servers and also preferably dispatches the newly generated keywords to advertisement serving system 26 servers.

Communication between all servers is preferably performed according to the HTTP protocol, optionally allowing the distribution of the servers in different geographic locations secured behind firewalls.

Examples of messages, which could be passed according to the operation of system 10, are provided as follows. Request for a cached URL will preferably result in an XML document with the following DTD:

```
<!-- Quigo AdSonar v1.0 Keywords Response DTD -->
<!ELEMENT QUIGO RESULTS (URL, KEYWORDS, THEMES),>
<!ATTLIST QUIGO_RESULTS status QDATA #REQUIRED>
<!ELEMENT URL (#PCDATA)>
<!ELEMENT KEYWORDS (KEYWORD+)>
<!ATTLIST KEYWORDS
    total CDATA #REQUIRED
    threshold CDATA #REQUIRED
    date_generated CDATA #REQUIRED
>
<!ELEMENT KEYWORD (#PCDATA)>
<!ATTLIST KEYWORD score CDATA #REQUIRED>
<!ELEMENT THEMES (THEME+)>
<!ELEMENT THEME (#PCDATA)>
<!ATTLIST THEME score CDATA #REQUIRED>
```

Example of a server response:

```
<?xml version=”1.0” encoding=”UTF-8” ?>
<QUIGO RESULTS status=”READY”>
    <URL><! [CDATA[ http://www.quigo.com ]]></URL>
    <KEYWORDS total=”5” threshold=”50” date_generated=
    ”mm/dd/yyyy” >
        <KEYWORD score = “94.6”><! [CDATA[ search engine paid
        inclusions ]]></KEYWORD>
        <KEYWORD score = “82.1”><! [CDATA[ search engine
        marketing campaign ]]></KEYWORD>
        <KEYWORD score = “81.6”><! [CDATA[ search engine
        campaign]]></KEYWORD>
        <KEYWORD score = “80.9”><! [CDATA[ search engine
        marketing service]]></KEYWORD></KEYWORDS>
    <THEMES >
        <THEME score = “64.6”><! [CDATA[ war ]]></THEME
        <THEME score = “55.3”><! [CDATA[ crime ]]></THEME>
        <THEME score = “47.2”;><! [CDATA[ tragedy ]]></THEME>
    < /THEMES'>
</QUIGO RESULTS>
```

The “Themes” element preferably includes a list of themes and their scores, and may be used by the publisher or by the search engines to disable ads based on specific themes. This list of themes should preferably be provided to key term mapping module 28 by the publisher or by the search engine beforehand. These themes are discussed above.

Request for a URL that is not yet cached will result in an XML that indicates that the requested URL is being processed. Example of an XML response indicating that the requested URL is being processed:

<?xml version=”1.0” encoding=”UTF-8” ?>
<QUIGO_RESULTS status=”PROCESSED”>
<URL.><![CDATA[ http://www.quigo.com.)],></URL>
</QUIGO RESULTS>

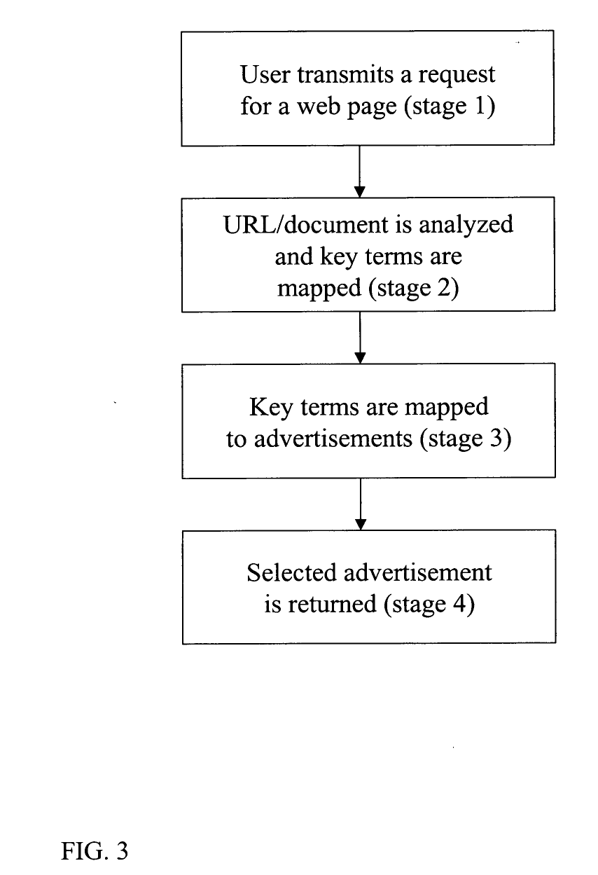

FIG. 3 shows an exemplary method according to the present invention for one such application of the present invention, which is related to targeted advertising. For this method, preferably one or both of the methods of FIGS. 1A and 1B are performed.

As shown in stage 1, a user transmits a request for a Web page. In stage 2, the Web page corresponding to the URL is preferably matched to the list of relevant key terms as previously described, more preferably by matching according to the key term feature vectors and feature vector for the Web page.

In stage 3, the key terms are preferably matched to at least one suitable advertisement, if not multiple advertisements. In stage 4, the selected advertisement(s) is then returned for display with the Web page.

According to an embodiment of the present invention, tools are provided for assisting in the implementation of the present invention. These tools may be provided as a suite of editorial applications. For example, one such application enables new target sites to be specified and sections and pages of the new target sites that are to be retrieved by an advertisement serving system and/or key term mapping server define. For example, in an e-commerce site, the editor may optionally specify that all product pages from only the book section should be retrieved.

Another application could enable field extraction definitions to be provided. For each target website, an editor preferably assists a short machine-learning process in which specific fields within the pages are tagged for extraction. For example, in a book site, the editor may choose to extract fields like book title, author, price, ISBN, description, availability, etc. The present invention preferably uses conventional advanced machine learning algorithms to automatically extract specific pieces of information from web pages, and to aggregate and restructure the information into XML documents. This process may be used to convert unstructured information to a structured document such as an XML document. This process may also be used to discard non-relevant information, such as the copyright notice on a web page, which, while legally relevant is not relevant to the content of the web page for purposes of improving relevancy of mapped search terms.

Another application could enable query terms to be discovered and associated with each URL, according to relevance with regard to the subject matter of each document. It could also enable automatic assignment of more generic key terms to category-level pages, home pages or to internal search result pages.

The present invention may provide a taxonomy editor, which allows operators to create global taxonomies to which elements extracted from HTML pages are mapped. During the extraction process, the operator preferably assigns web pages to a taxonomy node (a key term) and maps the page elements to fields derived from the taxonomy node. For example, by mapping a book page to the taxonomy node “books”, the operator is presented with a list of related fields such as “book title”, “author”, “ISBN”, “description” etc. The operator then tags each element on the page with its corresponding field name. The XML generated by the field extraction process may also use the taxonomy field names as the XML elements and attributes.

An embodiment of the present invention provides checking the relevancy of submitted key terms (submitted by advertisers, for example) to the content of an advertisement and/or other item. While an advertiser may submit a request for a key term, the operator of a PPC search engine and/or other advertisement selection mechanism typically determines whether the key term is actually relevant to the advertisement and/or other item that the advertiser has associated with the key term. This process prevents advertisers from purchasing popular but non-relevant key terms. The method of the present invention may optionally be used to automate this process, by mapping submitted key terms to feature vectors and automatically checking the relevancy of this key term feature vector with the document feature vector. This process checks the relevancy of the submitted titles and descriptions as well as the key terms to the documents.

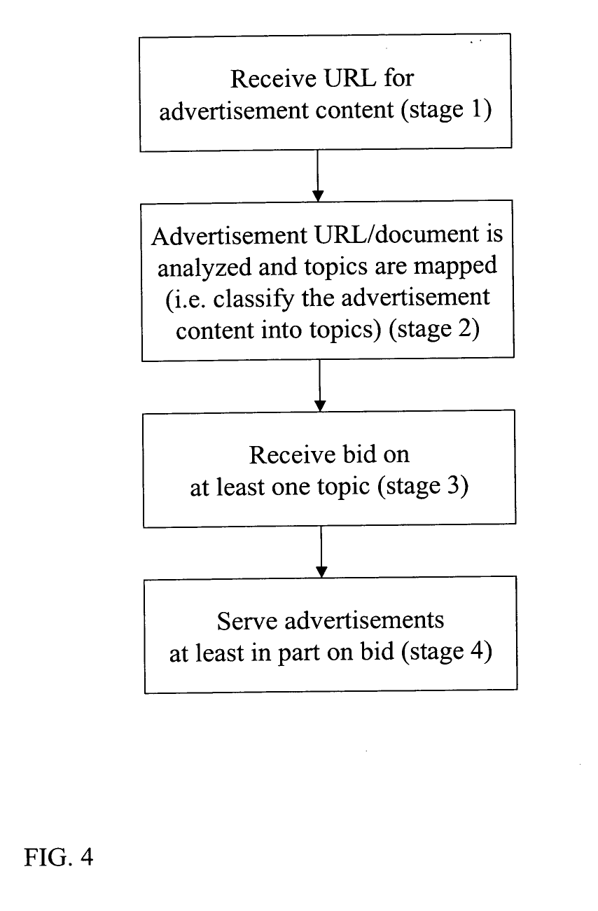

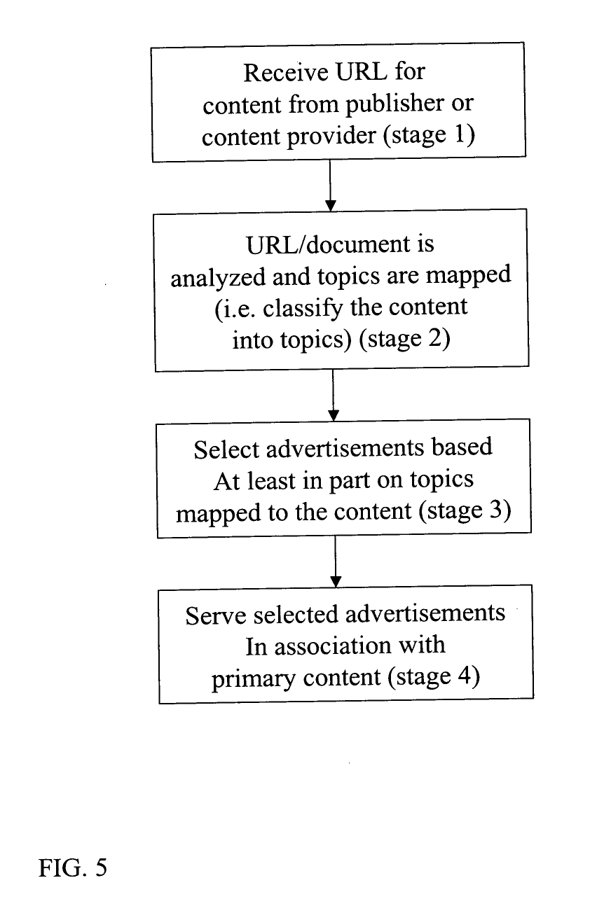

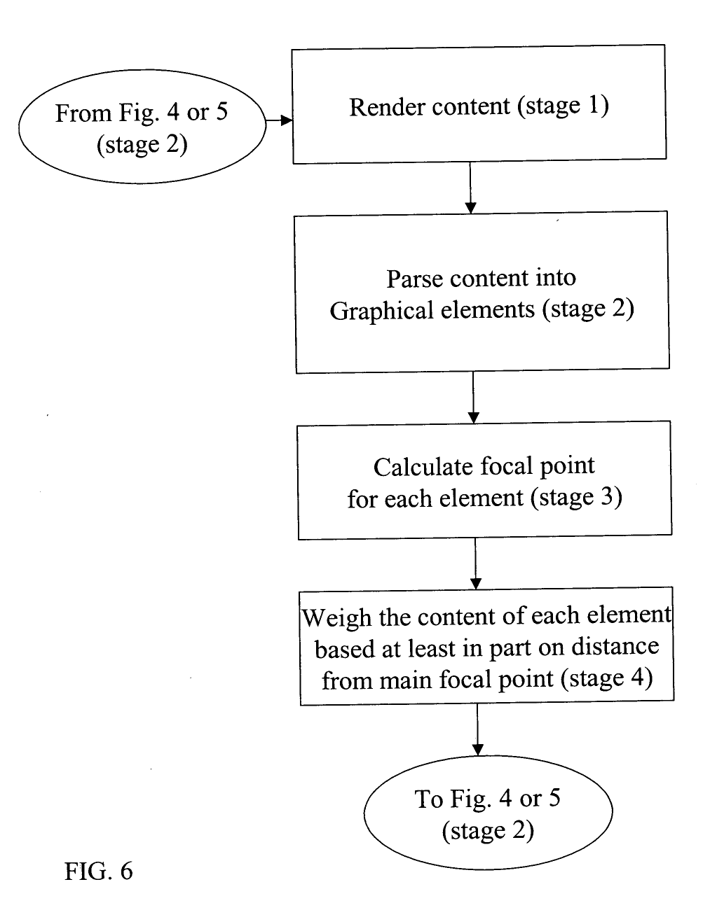

With reference to FIG. 6, an embodiment is provided for classifying the content of a document into key terms using a browser to render the content (stage 1) rather than a search engine. The system follows the user as the user navigates the Internet. The system parses the content into graphical elements (stage 2), calculates a focal point for each element (stage 3) and assigns a weight the content of each element based at least in part on the distance from the main focal point (stage 4). This method can be used as part of stage 2 of either FIG. 4 or 5. This method can be referred to as graphical parsing. One can use this graphical parsing method in conjunction with other convention methods for characterizing content of a web page. Conventional methods obtain attributes, e.g., hypertext markup language attributes, of the web pages using for example a crawler to crawl the web page. The attributes can include formatting, e.g., font size, color, and bold, and the number of incoming links to the page. Conventional methods weight the content of a page or portions of that content using the above-noted attributes.

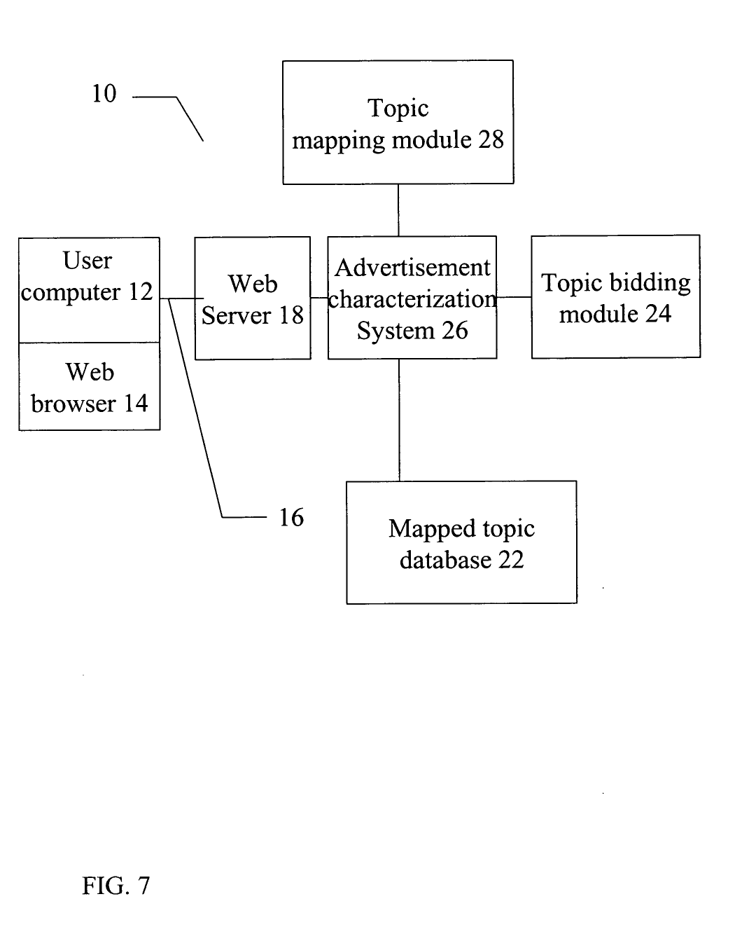

With reference to FIG. 7, an embodiment of the invention is provided which includes a server 18 operative to receive a URL for advertising content. An advertisement characterization system 26 is in communication with the server 18 as is a topic mapping module 28 (e.g., via the advertisement characterization system 26). The topic mapping module 28 maps key terms to the advertisement content. The system also includes a bidding module 30, which is in communication with the server 18 (e.g., via the advertisement characterization system 26) and/or the key term mapping module 28 and, which is receives bids for the key terms mapped to the advertisement content. When a URL is received by web server 18, web server 18 submits the URL to the advertisement characterization system 26. Alternatively, advertisement characterization system 26 and server 18 can be a single server that receives the URL directly from web browser 14 on user computer 12. In addition, the system can include a mapped key term database 22 in communication with the server 18 and/or the advertisement characterization system 26.

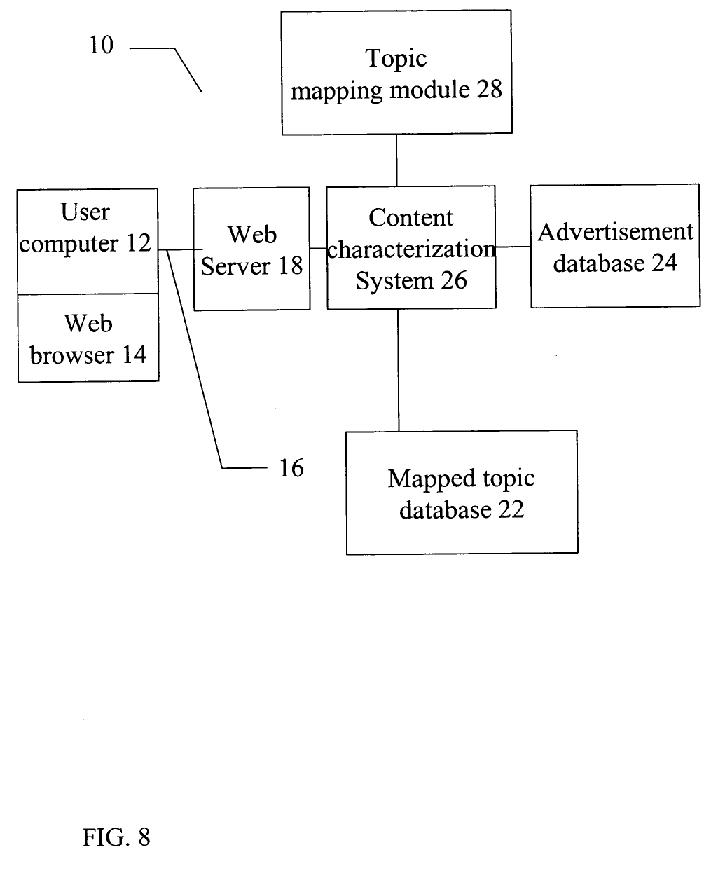

Embodiments of the invention may combine the methods of FIGS. 4 and 5 to provide automatic key term level matching between advertisers and publishers or content providers. Similarly, embodiments of the invention may combine the systems of FIGS. 7 and 8 to provide a system for automated key term level matching between advertisers and publishers or content providers.

It will be understood that changes may be made in the above construction and in the foregoing sequences of operation without departing from the scope of the invention. It is accordingly intended that all matter contained in the above description or shown in the accompanying drawings be interpreted as illustrative rather than in a limiting sense.

It is also to be understood that the following claims are intended to cover all of the generic and specific features of the invention as described herein, and all statements of the scope of the invention which, as a matter of language, might be said to fall therebetween.

1. A system for mapping an item to a document, the system comprising:
a server configured to receive a document and to determine a content of said document;
a mapping module in communication with the server and operative to correlate a key term to the content; and
an item database, in communication with the server, configured to store items;
wherein the server is configured to receive a key term correlated to the content from the mapping module, obtain an item from the item database based at least in part on the key term mapped to the content and to map the item to the document.

2. The system according to claim 1 wherein the document is a document selected from the group consisting of: a web site, a web page, a search query, a partial search query, a uniform resource locator (“URL”), an email, an advertisement and text.

3. The system according to claim 2, wherein the document includes a plurality of documents.

4. The system according to claim 1 wherein the item is an item selected from the group consisting of: an advertisement, a sound file, a graphic file, a video file, text, and another document.

5. The system according to claim 1 further comprising a taxonomy database in communication with said server and configured to store a plurality of key terms.

6. The system according to claim 1 wherein said key term represents a category of semantically unrelated words.

7. The system according to claim 1 further comprising a bidding module in communication with said server and configured to receive offers of payment for correlating said item to said key term.

8. A method of mapping an item to a document, the method comprising:
receiving a document;
analyzing the document to determine a content of the document;
comparing said content with a set of key terms;
correlating an item to at least one of the key terms in the set of key terms;
mapping said item to said document based on the results of the comparison including a match between said content and said at least one key term.

9. The method according to claim 8 wherein the document is a document selected from the group consisting of: a web site, a web page, a search query, a partial search query, a uniform resource locator (“URL”), an email, an advertisement and text.

10. The method according to claim 9 wherein the document is a search query and the item is search term; said mapping said item to said document including adding said search term to said search query to form an amended search query.

11. The method according to claim 10 further comprising submitting said amended search query to a search engine.

12. The method according to claim 8 wherein the item is an item selected from the group consisting of: an advertisement, a sound file, a graphic file, a video file, text, and another document.

13. The method according to claim 8 wherein said list of key terms is a list of categories of semantically unrelated words.

14. The method according to claim 8 further comprising offering said at least one key term for sale.

15. The method according to claim 14 further comprising offering a plurality of pre-selected key terms for sale wherein said plurality of pre-selected key terms includes said at least one key term.

16. The method according to claim 14 wherein said pre-selected key terms are assembled by receiving information from a potential purchaser of a key term, analyzing said information for information content, and comparing said information content to said set of key terms; wherein said pre-selected key terms include at least a subset of key terms found to match said information content.

17. The method according to claim 9 wherein said document is a web page having a menu; and, the content includes at least one element from said menu.

18. The method according to claim 9 wherein the content includes a plurality of elements from said menu.

19. The method according to claim 9 wherein said document has a plurality of menus and the content includes at least one element from each of at least 2 of said menus.

20. The method according to claim 8 wherein analyzing the document includes:
using a browser to render the content;
parsing the content into graphical elements;
calculating a focal point for each element; and
assigning a weight to the content of each element based at least in part on a distance from a main focal point.

21. A method of mapping an item to a document, the method comprising:
receiving a document;
analyzing the document to create a document feature vector;
and comparing said document feature vector with a set of key terms and related key term feature vectors.

22. The method according to claim 21 wherein said comparison results in a large number of matches; said method further comprising mapping said item to said document based on reasons other than the results of the comparison.

23. The method according to claim 22 wherein said mapping further comprises determining a search query frequently employed to reach the document; analyzing the search query to determine a content of the search query; comparing the content of the search query to the set of key terms and related key term feature vectors; correlating an item to at least one of the key terms in the set of key terms; and mapping said item to said document based on the results of the comparison including a match between said search query content and said at least one key term.

24. A system for mapping an item to a document, the system comprising:
means for receiving a document and a determining a content of said document;
means, in communication with the means for receiving, for correlating a key term to the content; and
an item database, in communication with the means for receiving, configured to store items;
wherein the means for receiving is configured to receive a key term correlated to the content from the means for correlating, obtain an item from the item database based at least in part on the key term correlated to the content and to map the item to the document.
